(19) United States
(12) Patent Application Publication
(10) Pub. No.: US 2011/0098915 A1
(43) Pub. Date: Apr. 28, 2011

(54) Device, system, and method of dynamic route guidance

(76) Inventors: Israel Disatnik, Bat Hefer (IL); Yuval Shmuelevitz, Ramat Hasharon (IL); Uri Levine, Kfar Saba (IL)

(21) Appl. No.: 12/588,786

(22) Filed: Oct. 28, 2009

(51) Int. Cl. G01C 21/36

(52) U.S. Cl. 701/201

(57) ABSTRACT

Device, system, and method of dynamic route guidance. For example, a method includes: calculating an optimal route from a first location, in which a navigation device is located, to a destination point entered by a user of said navigation device; receiving from the navigation device a travel update, indicating that the navigation device is located in a second location, wherein the second location is on said optimal route; and based on real-time traffic information and real-time road information, determining that an alternate route, from the second location to the destination point, is now an optimal route to the destination point.

### FIELD

Some embodiments are related to the field of navigation and route guidance.

### BACKGROUND

Some vehicles are equipped with a navigation device or route guidance device, which may include a mapping component (e.g., able to present a geographical map) and optionally a Global Positioning System (GPS) component (e.g., able to determine the current geographic location of the vehicle).

The navigation device may be able to present a map showing an origin point and a destination point; to present a driving route or a travel route from an origin point to a destination point; and/or to guide the user, by utilizing audio-visual instructions (e.g., “turn left”, “approaching a tunnel”), as the user travels along that route towards the destination point.

### SUMMARY

Some embodiments include, for example, devices, systems, and methods of dynamic route guidance.

In some embodiments, a method includes: calculating an optimal route from a first location, in which a navigation device is located, to a destination point entered by a user of said navigation device; receiving from the navigation device a travel update, indicating that the navigation device is located in a second location, wherein the second location is on said optimal route; and based on real-time traffic information and real-time road information, determining that an alternate route, from the second location to the destination point, is now an optimal route to the destination point.

In some embodiments, the method includes: updating the navigation device to reflect that the alternate route is a new optimal route replacing a previously-calculated optimal route to said destination point.

In some embodiments, the method includes: obtaining approval of the user of the navigation device prior to replacing the previously-calculated optimal route with said alternate route.

In some embodiments, the method includes: automatically replacing the previously-calculated optimal route with said alternate route independent of obtaining approval from the user of the navigation device.

In some embodiments, the method includes: automatically performing said replacing if an estimated travel time on the alternate route is smaller than an estimated travel time on the previously-calculated optimal route by at least a pre-defined time period.

In some embodiments, the method includes: automatically performing said replacing if an estimated travel time on the alternate route is smaller than an estimated travel time on the previously-calculated optimal route by at least a pre-defined percentage value.

In some embodiments, the method includes: automatically performing said replacing if the number of road segment of the alternate route is smaller than the number of road segments of the previously-calculated optimal route by at least a pre-defined threshold value.

In some embodiments, the method includes: substantially continuously calculating an optimal route from a current location of the navigation device to said destination point; and automatically replacing a previously-calculated optimal route with a newly-calculated optimal route.

In some embodiments, the step of determining that an alternate route is now an optimal route to the destination point is performed upon receiving a real-time traffic update comprising one or more of: data indicating a traffic jam in a road segment of the optimal route; data indicating slow traffic in a road segment of the optimal route; data indicating a vehicular accident in a road segment of the optimal route; data indicating a blockage in a road segment of the optimal route; data indicating removal of a blockage in a road segment of an alternate route; data indicating alleviation of a traffic jam in a road segment of an alternate route; data indicating increased velocity of traffic in a road segment of an alternate route.

In some embodiments, the step of determining that an alternate route is now an optimal route to the destination point is performed upon obtaining data comprising one or more of: data indicating a change in predicted traffic on one or more road segments in the optimal route; data indicating a change in predicted traffic on one or more road segments in an alternate route; data indicating a difference between estimated driving time and actual driving time along the already-traveled portion of the optimal route; data indicating that the user of the navigation device temporarily stopped the travel along the optimal route.

In some embodiments, the navigation device comprises a device selected from the group consisting of: a cellular phone, a Personal Digital Assistant (PDA) device, a smart-phone, a Portable Navigation Device (PND), a mobile navigation device, a portable navigation device, a mobile route guidance device, a mobile mapping device, a mobile traffic updates device, a vehicular navigation device, and a vehicular dashboard device.

In some embodiments, a system includes: a routing module to calculate an optimal route from a first location, in which a navigation device is located, to a destination point entered by a user of said navigation device; to receive from the navigation device a travel update, indicating that the navigation device is located in a second location, wherein the second location is on said optimal route; and based on real-time traffic information and real-time road information, to determine that an alternate route, from the second location to the destination point, is now an optimal route to the destination point.

In some embodiments, the routing module is to update the navigation device to reflect that the alternate route is a new optimal route replacing a previously-calculated optimal route to said destination point.

In some embodiments, the routing module is to obtain approval of the user of the navigation device prior to replacing the previously-calculated optimal route with said alternate route.

In some embodiments, the routing module is to automatically replace the previously-calculated optimal route with said alternate route independent of obtaining approval from the user of the navigation device.

In some embodiments, the routing module is to automatically perform said replacement if an estimated travel time on the alternate route is smaller than an estimated travel time on the previously-calculated optimal route by at least a pre-defined time period.

In some embodiments, the routing module is to automatically perform said replacement if an estimated travel time on the alternate route is smaller than an estimated travel time on the previously-calculated optimal route by at least a pre-defined percentage value.

In some embodiments, the routing module is to automatically perform said replacement if the number of road segment of the alternate route is smaller than the number of road segments of the previously-calculated optimal route by at least a pre-defined threshold value.

In some embodiments, the routing module is to substantially continuously calculate an optimal route from a current location of the navigation device to said destination point; and to automatically replace a previously-calculated optimal route with a newly-calculated optimal route.

In some embodiments, the routing module is to determine that an alternate route is now an optimal route to the destination point upon receiving a real-time traffic update comprising one or more of data indicating a traffic jam in a road segment of the optimal route; data indicating slow traffic in a road segment of the optimal route; data indicating a vehicular accident in a road segment of the optimal route; data indicating a blockage in a road segment of the optimal route; data indicating removal of a blockage in a road segment of an alternate route; data indicating alleviation of a traffic jam in a road segment of an alternate route; data indicating increased velocity of traffic in a road segment of an alternate route.

In some embodiments, the routing module is to determine that an alternate route is now an optimal route to the destination point upon obtaining data comprising one or more of: data indicating a change in predicted traffic on one or more road segments in the optimal route; data indicating a change in predicted traffic on one or more road segments in an alternate route; data indicating a difference between estimated driving time and actual driving time along the already-traveled portion of the optimal route; data indicating that the user of the navigation device temporarily stopped the travel along the optimal route.

In some embodiments, the navigation device comprises a device selected from the group consisting of: a cellular phone, a Personal Digital Assistant (PDA) device, a smart-phone, a Portable Navigation Device (PND), a mobile navigation device, a portable navigation device, a mobile route guidance device, a mobile mapping device, a mobile traffic updates device, a vehicular navigation device, and a vehicular dashboard device.

Some embodiments may include, for example, a computer program product including a computer-useable medium including a computer-readable program, wherein the computer-readable program when executed on a computer causes the computer to perform methods in accordance with some embodiments.

Some embodiments may provide other and/or additional benefits and/or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system in accordance with some demonstrative embodiments.

FIG. 2 is a schematic flow-chart of a method of dynamic route guidance, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Although portions of the discussion herein relate, for demonstrative purposes, to wired links and/or wired communications, some embodiments are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a Personal Navigation Device (PND), a hybrid device (e.g., a device incorporating functionalities of multiple types of devices, for example, PDA functionality and cellular phone functionality), a vehicular device, a non-vehicular device, a mobile or portable device, a non-mobile or non-portable device, a wireless communication station, a wireless communication device, a wireless Access Point (AP), a wireless Base Station (BS), a Mobile Subscriber Station (MSS), a wired or wireless Network Interface Card (NIC), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating in accordance with existing IEEE 802.11, 802.11a, 802.11b, 802.11g, 802.11n, 802.16, 802.16d, 802.16e, 802.16m standards and/or future versions and/or derivatives of the above standards, units and/or devices which are part of the above networks, one way and/or two-way radio communication systems, cellular radio-telephone communication systems, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or tag or transponder, a device which utilizes Near-Field Communication (NFC), a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, a “smartphone” device, a wired or wireless handheld device (e.g., BlackBerry®, Palm®Treo™), a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), OFDM Access (OFDMA), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, Multi-Carrier Modulation (MDM), Discrete Multi-Tone (DMT), Bluetooth®, Global Positioning System (GPS), IEEE 802.11 (“Wi-Fi”), IEEE 802.16 (“Wi-Max”), ZigBee™, Ultra-Wideband (UWB), Global System for Mobile communication (GSM), 2G, 2.5G, 3G, Third Generation Partnership Project (3GPP), 3GPP Long Term Evolution (LTE), 3.5G, or the like. Some embodiments may be used in conjunction with various other devices, components, systems, and/or networks.

The terms “wireless device” or “mobile device” or “mobile communication device” or “wireless communication device” as used herein include, for example, a device capable of wireless communication, a mobile phone, a cellular phone, a PDA capable of wireless communication, a portable device, a handheld device capable of wireless communication, or the like.

The term “user” as used herein includes, for example, a person or entity that owns a computing device or a wireless device; a person or entity that operates or utilizes a computing device or a wireless device; or a person or entity that is otherwise associated with a computing device or a wireless device.

At an overview, some embodiments may provide automatic rerouting or dynamic rerouting, by taking into account real-time information (e.g., traffic updates) which affect a current route traveled on and/or alternate route(s) not currently traveled on.

Some embodiments may be used in conjunction with a system capable of calculating and monitoring a navigation route between a designated origin point and a destination point, while taking into account real-time information updates.

In some embodiments, such systems may include, for example, a location-aware portable device, a Portable Navigation Device (PND), a Global Positioning System GPS device, a GPS-enabled mobile phone running navigation software or a Route Guidance (RG) software, or other portable devices or vehicular devices. The navigation device may be connected by a wireless connection to one or more dedicated servers able to can deliver optimal driving routes based on collected and/or calculated real-time road and traffic information.

In some embodiments, the system may be capable of calculating an optimal route (e.g., a shortest-time route) at any given time, taking into account one or more of the following data items: known or estimated average driving speeds on different roads; known or estimated average driving speeds per specific time periods, for example, day of the week and/or time of day; real-time traffic information (e.g., traffic jams, closed roads) collected from external sources; real-time traffic information collected from active users (e.g., drivers or passengers reporting traffic information); real-time traffic information calculated from monitored agents (e.g., vehicles carrying a monitored location-aware device and suitable software); predicted changes in real-time traffic information, based on collected and/or calculated data; and/or other known or estimated data items.

In some embodiments, while a vehicle travels along the route, changes in traffic conditions or diversions from the expected driving speed may make the optimal route (namely, the route from the current location along the original navigation route to the destination point) different from the originally-planned route that was recommended by the navigation system. In some embodiments, the system is able to detect such situations, and updates the active navigation route accordingly, such that the route taken by the vehicle remains optimal based on current information.

In some embodiments, when triggered, the system re-calculates the optimal route from the device's current location to the original destination point. If that route is different from the remaining part of the original route, then the newly-calculated optimal route is used as the active route starting at that time point.

In some embodiments, triggers for the recalculation may include one or more of the following: a predefined time had passed (e.g., periodical calculation); real-time road information updates along the original navigation route (e.g., a new traffic jam is detected along the way); real-time road information updates with regard to road segments that are not included in the originally-planned route (e.g., a road block on a near-by road has been cleared, or an alternate road segment that was temporarily closed to traffic is now open); changes in predicted traffic status for roads or road segments (e.g., located on the active route or outside of it), that may affect the driving speeds before the route is complete; user initiated triggers (e.g., the user initiates the re-calculation of the optimal route); differences between estimated and actual driving times along the already-traveled part of the route (e.g., the driver stopped mid-route for fuel or for a coffee break, and such delay may cause the driver to miss the target time or deadline for beating the rush-hour traffic on a road ahead on the route, and may thus require a new detour); and/or other conditions or situations.

In some embodiments, the newly-calculated route may be considered meaningfully different from the originally-calculated route based on one or more conditions or criteria, for example: the Estimated Time of Arrival (ETA) to the destination point is different from the originally-calculated ETA by a time period greater than a threshold value (e.g., more than one minute, more than 90 seconds); the ETA is different by more than a predefined ratio or percentage value (e.g., by more than 6 percent); the total length of roads or road segments, which are included in the current route but are not included on the newly-calculated alternate route is greater than a predefined threshold value; the number of turns (e.g., a turn including a pair of from-road and to-road) that are included on one route but not on the other route is greater than a predefined threshold value; and/or other suitable conditions or criteria.

In some embodiments, once the system calculates a new route, one or more suitable actions may be performed, for example: automatically update the active route displayed to the user of the navigation device and utilized by that user; update the active route based on user decision (e.g., subject to the user's confirmation to modify the currently-traveled route into the newly-calculated route); update the active route based on user-controlled settings (e.g., the user may set in advance whether or not to automatically update the active route, or conditions in which the active route may be or may not be automatically updated); notify the user only about the occurrence of the real-time update and allow the user to optionally initiate a reroute operation; and/or other suitable actions.

In some embodiments, if the active route is indeed changed to the newly-calculated optimal route, the system may switch to dynamically monitoring the new active route, and may utilize the above method to further perform the automatic, dynamic reroute.

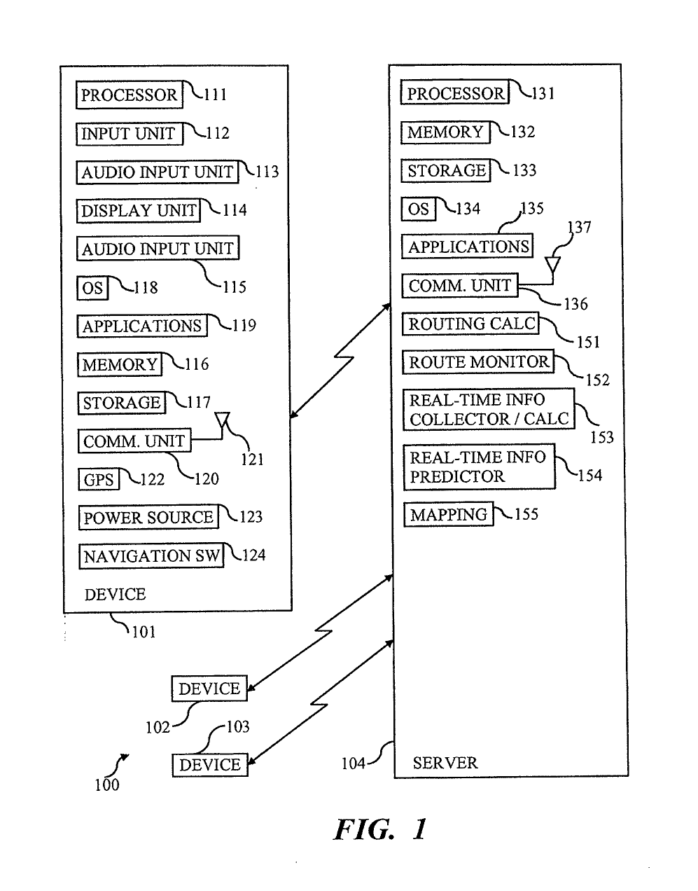

FIG. 1 schematically illustrates a block diagram of a system 100 in accordance with some demonstrative embodiments. System 100 includes multiple devices, for example, devices 101-103, as well as a server 104.

In some embodiments, each one of devices 101-103 may be implemented, for example, as a portable device, a handheld device, a Portable Navigation Device (PND), a cellular phone, a “smartphone” device, a Personal Digital Assistant (PDA) device, a GPS device, a GPS-enabled device or mobile phone, an iPhone or a similar device, an iPod or iPod Touch or similar device, an on-board or off-board device, a hybrid device (e.g., combining features of a PDA and a cellular phone), a wireless communication device, a vehicular device, an on-board device, a dashboard device, or the like. In some embodiments, each one of devices 101-103 may optionally be, or may include functions of, a portable audio player, a portable video player, a portable audio/video player, a portable media player, a portable device having a touch-screen, a relatively small computing device, a non-desktop computer or computing device, a portable device, a “Carry Small Live Large” (CSLL) device, an Ultra Mobile Device (UMD), an Ultra Mobile PC (UMPC), a Mobile Internet Device (MID), a Consumer Electronic (CE) device, an “Origami” device or computing device, a device that supports Dynamically Composable Computing (DCC), a context-aware device, a location-aware device, a device able to utilize Location-Based Services (LBS), or the like.

Devices 101-103 may be able to communicate among themselves, and/or may be able to communicate with server 104 (e.g., a route guidance server, a real-time server, a traffic server, a traffic updates server, a traffic prediction server), using one or more wireless communication links and/or networks. Communication may be performed, for example, over a shared access medium, an a-synchronic or asynchronous wireless network, a synchronic wireless network, a managed wireless network, a non-managed wireless network, a burstable wireless network, a non-burstable wireless network, a scheduled wireless network, a non-scheduled wireless network, a combination of networks or links, or the like. Communication may be performed using one or more suitable protocols, for example, Transmission Control Protocol (TCP), User Datagram Protocol (UDP), Hypertext Transfer Protocol (HTTP), Wireless Application Protocol (WAP), or other suitable protocol(s). The communication may include, for example, transmissions by devices 101-103 to server 104 of their location and/or velocity; transmissions by server 104 to devices 101-103 indicating traffic updates, traffic predictions, dynamic route guidance, and/or mapping information; or the like.

Each one of devices 101-103 may be implemented using suitable hardware components and/or software components. For demonstrative purposes, components of device 101 are shown, whereas similar components of devices 102-103 are not shown. For example, device 101 may include a processor 111, an input unit 112, an audio input unit 113, a display unit 115, an audio output unit 116, a memory unit 117, a storage unit 118, a communication unit 119, and/or other suitable components.

Processor 111 includes, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or other suitable multi-purpose or specific processor or controller. Processor 111 executes instructions, for example, of an Operating System (OS) 118 or of one or more applications 119, for example, navigation software 124.

Input unit 112 includes, for example, a keyboard, a keypad, a mouse, a touch-pad, a touch-screen, a joystick, a track-ball, a stylus, or other suitable pointing unit or input device.

Audio input unit 113 may include, for example, a microphone or a line-in socket able to receive audio input from the user of device 101. The received audio may optionally include speech commands, which may trigger voice-activated or voice-operated actions to be performed by device 101. For example, the audio input unit 113 may be used to receive from a user a speech indication of a destination (e.g., an address of a destination), and this audio input may be used by a navigation application of device 101 in order to guide the user in navigating to that destination.

Display unit 114 may include, for example, a Liquid Crystal Display (LCD) display unit, a plasma display unit, or other suitable types of displays or screens. In some embodiments, display unit 114 may include a touch-screen, such that display unit 114 may be able to present output as well as to receive touch-based input or multi-touch input.

Audio output unit 115 may include, for example, one or more speakers or earphones or line-out sockets able to produce audio output. In some embodiments, for example, output generated by device 101 may be presented visually on the display unit 114, and/or may be presented audibly as audio output using the audio output unit 115.

Memory unit 116 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 117 includes, for example, a hard disk drive, a floppy disk drive, a Compact Disk (CD) drive, a CD-ROM drive, a Digital Versatile Disk (DVD) drive, an internal or external database or repository, or other suitable removable or non-removable storage units. Memory unit 116 and/or storage unit 117 may, for example, store data processed by device 101.

Communication unit 120 includes, for example, a wired or wireless transceiver, a wired or wireless modem, a wired or wireless Network Interface Card (NIC) or adapter, or other unit suitable for transmitting and/or receiving communication signals, blocks, frames, transmission streams, packets, messages and/or data. In some embodiments, for example, communication unit 120 may include a wireless Radio Frequency (RF) transceiver able to transmit and/or receive wireless RF signals, e.g., through one or more antennas 121 or sets of antennas. For example, such transceiver may be implemented using a transmitter, a receiver, a transmitter-receiver, or one or more units able to perform separate or integrated functions of transmitting and/or receiving wireless communication signals, blocks, frames, transmission streams, packets, messages and/or data.

Antenna 121 may include an internal and/or external antenna, for example, a RF antenna, a dipole antenna, a monopole antenna, an omni-directional antenna, an end fed antenna, a circularly polarized antenna, a micro-strip antenna, a diversity antenna, or any other type of antenna suitable for transmitting and/or receiving wireless communication signals, blocks, frames, transmission streams, packets, messages and/or data.

Device 101 may optionally include a GPS receiver 122, able to receive signal(s) from one or more satellites (or other signal sources) and to determine the spatial location of device 101, for example, based on trilateration or other suitable method.

In some embodiments, device 110 further includes a power source 123, for example, a power-cell or battery, a rechargeable power-cell or battery, one or more electro-chemical cells, a lithium ion (Li-ion) battery, a Li-ion polymer battery, a nickel cadmium (NiCd) battery, a nickel metal hydride (NiMH) battery, a nickel hydrogen (NIH2) battery, or the like. Power source 123 may be associated with a power controller, which may be able to control, regulate and/or modify the power (e.g., the voltage and/or the current) supplied by the power source 123 to other components of device 101 (e.g., to processor 111, to display unit 114, or the like).

In some embodiments, some or all of the components of device 101 are enclosed in a common housing or packaging, and are interconnected or operably associated using one or more wired or wireless links.

In some embodiments, each one of devices 102-103 may include components which may be similar to the components of device 101. In some embodiments, each one of devices 101-103 may be associated with a user, for example, a driver, a passenger, a pedestrian, a person associated with a vehicle, a person not associated with a vehicle, or the like.

In some embodiments, server 104 may be stationary, non-mobile, or non-portable. In some embodiments, server 104 may include components which may be similar to the components of device 101, for example, a processor 131, a memory unit 132, a storage unit 133, an OS 134, one or more application 135, a communication unit 136, an antenna 137, or the like.

Server 104 may further include, for example, a routing calculator 151, a route monitor 152, a real-time information collector/calculator 153, and optionally a real-time information predictor 154, as well as other suitable software module and/or hardware components. In some embodiments, the routing calculator 151 and/or the route monitor 152 may be included (as software modules and/or hardware components) in device 101, or may otherwise be client-side components and not necessarily server-side components. In some embodiments, the routing calculator 151 and the route monitor 152 may be implemented as a single unit or module. In some embodiments, the real-time information collector/calculator 153 and the real-time information predictor 154 may be implemented as a single unit or module. Other suitable implementations may be used.

For demonstrative purposes, portions of the discussion herein correspond to some embodiments in which the routing calculator 151 and/or the route monitor 152 are server-side components included in server 104; although similar methods may be performed if such components are client-side components.

In some embodiments, the user of device 101 may input an origin point and a destination point, and may request an optimal route from the origin point to the destination point. In other embodiments, device 101 may be location-aware (e.g., by utilizing the GPS receiver 122), and thus the user of device 101 may input only a destination point and may request an optimal route from the current location of device 101 to the destination point provided by the user. For demonstrative purposes, portions of the discussion herein correspond to some embodiments in which device 101 is a location-aware device.

Based on the query entered by the user of device 101, device 101 sends to server 104 a routing request, namely, a request for data representing the optimal route from the current location of device 101 to the destination point defined by the user of device 101. In response to the routing request, the routing calculator 151 of server 104 calculates one or more possible routes to the destination point (e.g., optionally using a mapping module 155 or other suitable module or database), and selects the optimal route to the destination point (e.g., based on travel time, travel distance, travel price, or other parameters provided or configured by the user of device 101). Server 104 sends back to device 101 data representing such optimal route, which may be referred to herein as “originally-calculated optimal route”.

As the user of device 101 travels along the originally-calculated optimal route, device 101 may send to server 104 progress updates, notifying the server 104 about the updated location of device 101. Such progress updated may be registered by the route monitor 152 of server 104.

In server 104, the real-time information collector/calculator 153 operates to collect and/or calculate real-time information, for example, road or road-segment information (e.g., a road becomes blocked, a road-block is cleared or removed), traffic information (e.g., traffic jam on a particular road or road-segment), and/or other information which may affect the travel time or travel distance or other travel parameters of users. In some embodiments, such updates may be received from a separate or remote device, for example, traffic updates server or traffic information server. Optionally, the real-time information predictor 154 of server 104 may estimate such information or may predict such updates, and may feed such predictions or estimations to the real-time information collector/calculator 153. The real-time information collector/calculator 153 transfers all such collected data, calculated data and predicted data to the route monitor 152 and to the routing calculator 151.

The route monitor 152 may monitor the route that device 101 travels on, based on travel updates received from device 101, and based on real-time road information, traffic information, and other travel-affecting information that the real-time information collector/calculator 153 sends to the route monitor 152. Accordingly, the route monitor 152 may send a routing request to the routing calculator 151, which in response may re-calculate and send an optimal route from the current location of device 100 to the destination point (“newly-calculated optimal route”). Additionally, the route monitor 152 may send an Estimated Time of Arrival (ETA) request to the routing calculator 151, which in response may re-calculate and send the ETA data for the newly-calculated optimal route.

The route monitor 152 may now determine whether or not the originally-calculated optimal route, on which device 101 now travels, should be replaced with the newly-calculated optimal route. The determination may be performed based on one or more parameters or user-configurable settings, for example, the travel time expected to be saved by replacing the originally-calculated optimal route with the newly-calculated optimal route; the percentage of travel time (or travel distance) expected to be saved by such replacement; whether or not the user requested to confirm such replacement in general or if certain conditions are met; and/or other suitable conditions.

If the route monitor 152 determines to replace the originally-calculated optimal route with the newly-calculated optimal route, then server 104 may send to device 101 route updates, namely, data representing the newly-calculate optimal route from the current location of device 101 to the destination point. Device 101 may thus present to its user the updated route guidance information or instructions, reflecting the newly-calculated optimal route from the current location of device 101 to the destination point.

The process may be performed substantially continuously, for example, until device 101 reaches its destination point; or at pre-defined time intervals (e.g., every minute, every two minutes); upon the request of the user of device 101; or based upon other triggers. Once the originally-calculated optimal route is replaced by a newly-calculated optimal route, that newly-calculated optimal route becomes the basis to which subsequent newly-calculated optimal route(s) are dynamically compared.

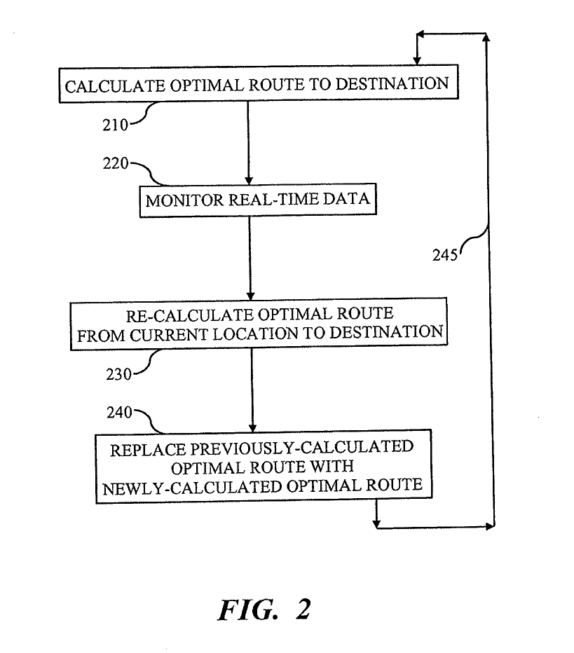

FIG. 2 is schematic flow-chart of a method of dynamic route guidance, in accordance with some demonstrative embodiments. Operations of the method may be used, for example, by system 100 of FIG. 1, by server 104 of FIG. 1, and/or by other suitable units, devices and/or systems.

In some embodiments, the method may include, for example, determining or calculating an optimal route from a location of a device to a destination point (block 210).

In some embodiments, the method may include, for example, monitoring real-time data which may affect other possible routes to the destination point (block 220). Such monitoring may include, for example, receiving or collecting real-time traffic updates or road updates, or calculating or predicting traffic updates or road updates.

In some embodiments, the method may include, for example, re-calculating the optimal route from the current location of the device to the destination point (block 230). Such re-calculations take into account the collected real-time data.

In some embodiments, the method may include, for example, replacing the optimal route with another, newly-calculated, optimal route to the destination point (block 240).

In some embodiments, the method may include, for example, repeating the operations of blocks 220 and onward (arrow 245). Accordingly, that the route to the destination point is continuously monitored, and is updated or replaced with a newly-calculated optimal route based on real-time data.

Other suitable operations or sets of operations may be used in accordance with some embodiments. Some operations or sets of operations may be repeated, for example, substantially continuously, for a pre-defined number of iterations, or until one or more conditions are met. In some embodiments, some operations may be performed in parallel, in sequence, or in other suitable orders of execution.

The terms “plurality” or “a plurality” as used herein include, for example, “multiple” or “two or more”. For example, “a plurality of items” includes two or more items.

Discussions herein utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some embodiments may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be or may include an electronic, magnetic, optical, electromagnetic, InfraRed (IR), or semiconductor system (or apparatus or device) or a propagation medium. Some demonstrative examples of a computer-readable medium may include a semiconductor or solid state memory, magnetic tape, a removable computer diskette, a Random Access Memory (RAM), a Read-Only Memory (ROM), a rigid magnetic disk, an optical disk, or the like. Some demonstrative examples of optical disks include Compact Disk—Read-Only Memory (CD-ROM), Compact Disk—Read/Write (CD-R/W), DVD, or the like.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Some embodiments may be implemented by software, by hardware, or by any combination of software and/or hardware as may be suitable for specific applications or in accordance with specific design requirements. Some embodiments may include units and/or sub-units, which may be separate of each other or combined together, in whole or in part, and may be implemented using specific, multi-purpose or general processors or controllers. Some embodiments may include buffers, registers, stacks, storage units and/or memory units, for temporary or long-term storage of data or in order to facilitate the operation of particular implementations.

Some embodiments may be implemented, for example, using a machine-readable medium or article which may store an instruction or a set of instructions that, if executed by a machine, cause the machine to perform a method and/or operations described herein. Such machine may include, for example, any suitable processing platform, computing platform, computing device, processing device, electronic device, electronic system, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit; for example, memory, removable or non-removable media, erasable or non-erasable media, writeable or re-writeable media, digital or analog media, hard disk drive, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the following claims are intended to cover all such modifications, substitutions, changes, and equivalents.

What is claimed is:

1. A method comprising:
calculating an optimal route from a first location, in which a navigation device is located, to a destination point entered by a user of said navigation device;
receiving from the navigation device a travel update, indicating that the navigation device is located in a second location, wherein the second location is on said optimal route; and
based on real-time traffic information and real-time road information, determining that an alternate route, from the second location to the destination point, is now an optimal route to the destination point.

2. The method of claim 1, further comprising:
updating the navigation device to reflect that the alternate route is a new optimal route replacing a previously-calculated optimal route to said destination point.

3. The method of claim 2, further comprising:
obtaining approval of the user of the navigation device prior to replacing the previously-calculated optimal route with said alternate route.

4. The method of claim 2, comprising:
automatically replacing the previously-calculated optimal route with said alternate route independent of obtaining approval from the user of the navigation device.

5. The method of claim 4, comprising:
automatically performing said replacing if an estimated travel time on the alternate route is smaller than an estimated travel time on the previously-calculated optimal route by at least a pre-defined time period.

6. The method of claim 4, comprising:
automatically performing said replacing if an estimated travel time on the alternate route is smaller than an estimated travel time on the previously-calculated optimal route by at least a pre-defined percentage value.

7. The method of claim 4, comprising:
automatically performing said replacing if the number of road segment of the alternate route is smaller than the number of road segments of the previously-calculated optimal route by at least a pre-defined threshold value.

8. The method of claim 1, comprising:
substantially continuously calculating an optimal route from a current location of the navigation device to said destination point; and
automatically replacing a previously-calculated optimal route with a newly-calculated optimal route.

9. The method of claim 1, wherein the step of determining that an alternate route is now an optimal route to the destination point is performed upon receiving a real-time traffic update comprising one or more of:
data indicating a traffic jam in a road segment of the optimal route;
data indicating slow traffic in a road segment of the optimal route;
data indicating a vehicular accident in a road segment of the optimal route;
data indicating a blockage in a road segment of the optimal route;
data indicating removal of a blockage in a road segment of an alternate route;
data indicating alleviation of a traffic jam in a road segment of an alternate route;
data indicating increased velocity of traffic in a road segment of an alternate route.

10. The method of claim 1, wherein the step of determining that an alternate route is now an optimal route to the destination point is performed upon obtaining data comprising one or more of:
data indicating a change in predicted traffic on one or more road segments in the optimal route;
data indicating a change in predicted traffic on one or more road segments in an alternate route;
data indicating a difference between estimated driving time and actual driving time along the already-traveled portion of the optimal route;
data indicating that the user of the navigation device temporarily stopped the travel along the optimal route.

11. The method of claim 1, wherein the navigation device comprises a device selected from the group consisting of:
a cellular phone, a Personal Digital Assistant (PDA) device, a smart-phone, a Portable Navigation Device (PND), a mobile navigation device, a portable navigation device, a mobile route guidance device, a mobile mapping device, a mobile traffic updates device, a vehicular navigation device, and a vehicular dashboard device.

12. A system comprising:
a routing module to calculate an optimal route from a first location, in which a navigation device is located, to a destination point entered by a user of said navigation device; to receive from the navigation device a travel update, indicating that the navigation device is located in a second location, wherein the second location is on said optimal route; and based on real-time traffic information and real-time road information, to determine that an alternate route, from the second location to the destination point, is now an optimal route to the destination point.

13. The system of claim 12, wherein the routing module is to update the navigation device to reflect that the alternate route is a new optimal route replacing a previously-calculated optimal route to said destination point.

14. The system of claim 13, wherein the routing module is to obtain approval of the user of the navigation device prior to replacing the previously-calculated optimal route with said alternate route.

15. The system of claim 13, wherein the routing module is to automatically replace the previously-calculated optimal route with said alternate route independent of obtaining approval from the user of the navigation device.

16. The system of claim 15, wherein the routing module is to automatically perform said replacement if an estimated travel time on the alternate route is smaller than an estimated travel time on the previously-calculated optimal route by at least a pre-defined time period.

17. The system of claim 15, wherein the routing module is to automatically perform said replacement if an estimated travel time on the alternate route is smaller than an estimated travel time on the previously-calculated optimal route by at least a pre-defined percentage value.

18. The system of claim 15, wherein the routing module is to automatically perform said replacement if the number of road segment of the alternate route is smaller than the number of road segments of the previously-calculated optimal route by at least a pre-defined threshold value.

19. The system of claim 12, wherein the routing module is to substantially continuously calculate an optimal route from a current location of the navigation device to said destination point; and to automatically replace a previously-calculated optimal route with a newly-calculated optimal route.

20. The system of claim 12, wherein the routing module is to determine that an alternate route is now an optimal route to the destination point upon receiving a real-time traffic update comprising one or more of:
data indicating a traffic jam in a road segment of the optimal route;
data indicating slow traffic in a road segment of the optimal route;
data indicating a vehicular accident in a road segment of the optimal route;
data indicating a blockage in a road segment of the optimal route;
data indicating removal of a blockage in a road segment of an alternate route;
data indicating alleviation of a traffic jam in a road segment of an alternate route;
data indicating increased velocity of traffic in a road segment of an alternate route.

21. The system of claim 12, wherein the routing module is to determine that an alternate route is now an optimal route to the destination point upon obtaining data comprising one or more of:
data indicating a change in predicted traffic on one or more road segments in the optimal route;
data indicating a change in predicted traffic on one or more road segments in an alternate route;
data indicating a difference between estimated driving time and actual driving time along the already-traveled portion of the optimal route;
data indicating that the user of the navigation device temporarily stopped the travel along the optimal route.

22. The system of claim 12, wherein the navigation device comprises a device selected from the group consisting of:
a cellular phone, a Personal Digital Assistant (PDA) device, a smart-phone, a Portable Navigation Device (PND), a mobile navigation device, a portable navigation device, a mobile route guidance device, a mobile mapping device, a mobile traffic updates device, a vehicular navigation device, and a vehicular dashboard device.
